(19) United States
(12) Patent Application Publication
(10) Pub. No.: US 2022/0268596 A1
(43) Pub. Date: Aug. 25, 2022

(54) MAP GENERATION APPARATUS

(71) Applicant: Honda Motor Co., Ltd., Tokyo (JP)

(72) Inventors: Tokitomo Ariyoshi, Wako-shi (JP); Yuichiro Maeda, Tokyo (JP)

(21) Appl. No.: 17/676,187

(22) Filed: Feb. 20, 2022

(30) Foreign Application Priority Data
Feb. 25, 2021 (JP) 2021-028504

(51) Int. Cl. G01C 21/00; B60W 60/00

(52) U.S. Cl. CPC G01C 21/3815; B60W 60/001; B60W 2556/40

(57) ABSTRACT

A map generation apparatus including a detection device that detects an external situation around a subject vehicle, and an electronic control unit including a microprocessor and a memory connected to the microprocessor. The microprocessor is configured to perform generating simultaneously a first map for a current lane on which the subject vehicle travels and a second map for an opposite lane opposite to the current lane, based on the external situation detected by the detection device.

### CROSS-REFERENCE TO RELATED APPLICATION

This application is based upon and claims the benefit of priority from Japanese Patent Application No. 2021-028504 filed on Feb. 25, 2021, the content of which is incorporated herein by reference.

### BACKGROUND OF THE INVENTION

### Field of the Invention

This invention relates to a map generation apparatus configured to generate a map around a subject vehicle.

### Description of the Related Art

Conventionally, there is a known apparatus in which white lines of a lane and a parking lot frame are recognized using an image captured by a camera mounted on a vehicle, and the recognition results of the white lines are used for vehicle driving control and parking support. Such an apparatus is described, for example, in Japanese Unexamined Patent Publication No. 2014-104853 (JP2014-104853A). In the apparatus disclosed in JP2014-104853A, edge points at which a change in luminance in the captured image is equal to or greater than a threshold is extracted, and the white lines are recognized based on the edge points.

In the apparatus described in JP2014-104853A, a white line is recognized for a lane on which a subject vehicle has actually traveled. Therefore, in order to generate a map including position information of the white line, it is necessary for the subject vehicle to actually travel in each lane, and it is difficult to efficiently generate the map.

### SUMMARY OF THE INVENTION

An aspect of the present invention is a map generation apparatus including a detection device that detects an external situation around a subject vehicle, and an electronic control unit including a microprocessor and a memory connected to the microprocessor. The microprocessor is configured to perform generating simultaneously a first map for a current lane on which the subject vehicle travels and a second map for an opposite lane opposite to the current lane, based on the external situation detected by the detection device.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system having a map generation apparatus according to an embodiment of the present invention;

FIG. 2A is a view illustrating an example of a traveling scene to which the map generation apparatus according to the embodiment of the invention is applied;

FIG. 2B is a view illustrating another example of a traveling scene to which the map generation apparatus according to the embodiment of the invention is applied;

FIG. 3 is a block diagram illustrating a configuration of a substantial part of the map generation apparatus according to the embodiment of the invention;

FIG. 4A is a view illustrating an example of mirroring of an outward path map;

FIG. 4B is a diagram illustrating a relationship between a detectable area and a mirroring area; and

FIG. 5 is a flowchart illustrating an example of processing executed by a controller in FIG. 3.

### DETAILED DESCRIPTION OF THE INVENTION

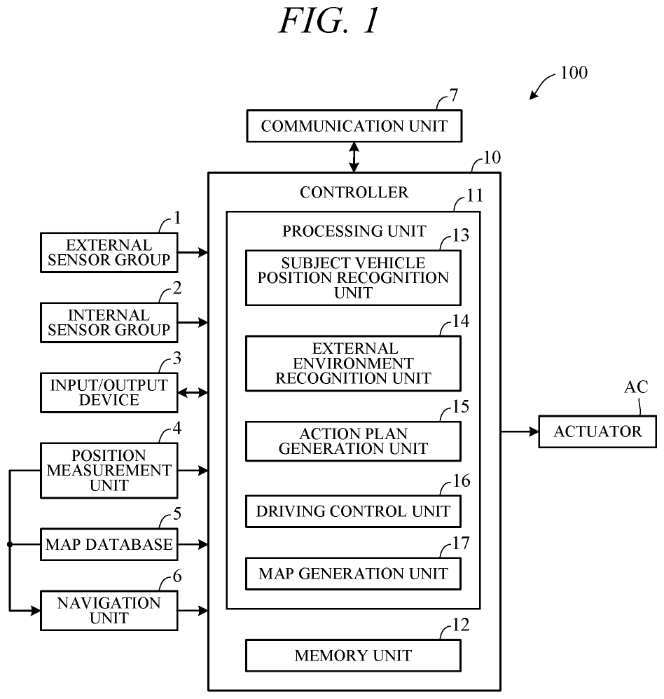

Hereinafter, an embodiment of the present invention is explained with reference to FIGS. 1 to 5. A map generation apparatus according to an embodiment of the invention is applied to a vehicle having a self-driving capability, i.e., a self-driving vehicle, for example. The self-driving vehicle having the map generation apparatus may be sometimes called “subject vehicle” to differentiate it from other vehicles. The subject vehicle is an engine vehicle having an internal combustion engine (engine) as a travel drive source, electric vehicle having a travel motor as the travel drive source, or hybrid vehicle having both of the engine and the travel motor as the travel drive source. The subject vehicle can travel not only in a self-drive mode in which a driving operation by a driver is unnecessary, but also in a manual drive mode in which the driving operation by the driver is necessary.

First, the general configuration of the subject vehicle for self-driving will be explained. FIG. 1 is a block diagram schematically illustrating an overall configuration of a vehicle control system 100 of the subject vehicle having the map generation apparatus according to an embodiment of the present invention. As shown in FIG. 1, the vehicle control system 100 mainly includes a controller 10, and an external sensor group 1, an internal sensor group 2, an input/output device 3, a position measurement unit 4, a map database 5, a navigation unit 6, a communication unit 7 and actuators AC which are communicably connected with the controller 10.

The term external sensor group 1 herein is a collective designation encompassing multiple sensors (external sensors) for detecting external circumstances constituting subject vehicle ambience data. For example, the external sensor group 1 includes, inter alia, a LIDAR (Light Detection and Ranging) for measuring distance from the subject vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways).

The term internal sensor group 2 herein is a collective designation encompassing multiple sensors (internal sensors) for detecting driving state of the subject vehicle. For example, the internal sensor group 2 includes, inter alia, a vehicle speed sensor for detecting vehicle speed of the subject vehicle, acceleration sensors for detecting forward-rearward direction acceleration and lateral acceleration of the subject vehicle, respectively, rotational speed sensor for detecting rotational speed of the travel drive source, a yaw rate sensor for detecting rotation angle speed around a vertical axis passing center of gravity of the subject vehicle and the like. The internal sensor group 2 also includes sensors for detecting driver driving operations in manual drive mode, including, for example, accelerator pedal operations, brake pedal operations, steering wheel operations and the like.

The term input/output device 3 is used herein as a collective designation encompassing apparatuses receiving instructions input by the driver and outputting information to the driver. The input/output device 3 includes, inter alia, switches which the driver uses to input various instructions, a microphone which the driver uses to input voice instructions, a display for presenting information to the driver via displayed images, and a speaker for presenting information to the driver by voice.

The position measurement unit (GNSS unit) 4 includes a position measurement sensor for receiving signal from positioning satellites to measure the location of the subject vehicle. The positioning satellites are satellites such as GPS satellites and Quasi-Zenith satellite. The position measurement unit 4 measures absolute position (latitude, longitude and the like) of the subject vehicle based on signal received by the position measurement sensor.

The map database 5 is a unit storing general map data used by the navigation unit 6 and is, for example, implemented using a magnetic disk or semiconductor element. The map data include road position data and road shape (curvature etc.) data, along with intersection and road branch position data. The map data stored in the map database 5 are different from high-accuracy map data stored in a memory unit 12 of the controller 10.

The navigation unit 6 retrieves target road routes to destinations input by the driver and performs guidance along selected target routes. Destination input and target route guidance is performed through the input/output device 3. Target routes are computed based on current position of the subject vehicle measured by the position measurement unit 4 and map data stored in the map database 35. The current position of the subject vehicle can be measured, using the values detected by the external sensor group 1, and on the basis of this current position and high-accuracy map data stored in the memory unit 12, target route may be calculated.

The communication unit 7 communicates through networks including the Internet and other wireless communication networks to access servers (not shown in the drawings) to acquire map data, travel history information, traffic data and the like, periodically or at arbitrary times. In addition to acquiring travel history information, travel history information of the subject vehicle may be transmitted to the server via the communication unit 7. The networks include not only public wireless communications network, but also closed communications networks, such as wireless LAN, Wi-Fi and Bluetooth, which are established for a predetermined administrative area. Acquired map data are output to the map database 5 and/or memory unit 12 via the controller 10 to update their stored map data.

The actuators AC are actuators for traveling of the subject vehicle. If the travel drive source is the engine, the actuators AC include a throttle actuator for adjusting opening angle of the throttle valve of the engine (throttle opening angle). If the travel drive source is the travel motor, the actuators AC include the travel motor. The actuators AC also include a brake actuator for operating a braking device and turning actuator for turning the front wheels FW.

The controller 10 is constituted by an electronic control unit (ECU). More specifically, the controller 10 incorporates a computer including a CPU or other processing unit (a microprocessor) 51 for executing a processing in relation to travel control, the memory unit (a memory) 12 of RAM, ROM and the like, and an input/output interface or other peripheral circuits not shown in the drawings. In FIG. 1, the controller 10 is integrally configured by consolidating multiple function-differentiated ECUs such as an engine control ECU, a transmission control ECU and so on. Optionally, these ECUs can be individually provided.

The memory unit 12 stores high-accuracy detailed road map data (road map information) for self-driving. The road map information includes information on road position, information on road shape (curvature, etc.), information on gradient of the road, information on position of intersections and branches, information on type and position of division line such as white line, information on the number of lanes, information on width of lane and the position of each lane (center position of lane and boundary line of lane), information on position of landmarks (traffic lights, signs, buildings, etc.) as a mark on the map, and information on the road surface profile such as unevennesses of the road surface, etc. The map information stored in the memory unit 12 includes map information (referred to as external map information) acquired from the outside of the subject vehicle through the communication unit 7, and map information (referred to as internal map information) created by the subject vehicle itself using the detection values of the external sensor group 1 or the detection values of the external sensor group 1 and the internal sensor group 2.

The external map information is, for example, information of a map (called a cloud map) acquired through a cloud server, and the internal map information is information of a map (called an environmental map) consisting of point cloud data generated by mapping using a technique such as SLAM (Simultaneous Localization and Mapping). The external map information is shared by the subject vehicle and other vehicles, whereas the internal map information is unique map information of the subject vehicle (e.g., map information that the subject vehicle has alone). In an area in which no external map information exists, such as a newly established road, an environmental map is created by the subject vehicle itself. The internal map information may be provided to the server or another vehicle via the communication unit 7. The memory unit 12 also stores information such as programs for various controls, and thresholds used in the programs.

As functional configurations in relation to mainly self-driving, the processing unit 11 includes a subject vehicle position recognition unit 13, an external environment recognition unit 14, an action plan generation unit 15, a driving control unit 16, and a map generation unit 17.

The subject vehicle position recognition unit 13 recognizes the position of the subject vehicle (subject vehicle position) on the map based on position information of the subject vehicle calculated by the position measurement unit 4 and map information stored in the map database 5. Optionally, the subject vehicle position can be recognized using map information stored in the memory unit 12 and ambience data of the subject vehicle detected by the external sensor group 1, whereby the subject vehicle position can be recognized with high accuracy. The movement information (movement direction, movement distance) of the subject vehicle is calculated based on the detection value of the internal sensor group 2, thereby it is also possible to recognize the position of the subject vehicle. Optionally, when the subject vehicle position can be measured by sensors installed externally on the road or by the roadside, the subject vehicle position can be recognized with high accuracy by communicating with such sensors through the communication unit 7.

The external environment recognition unit 14 recognizes external circumstances around the subject vehicle based on signals from cameras, LIDERs, RADARs and the like of the external sensor group 1. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road, buildings, guardrails, power poles, commercial signs, pedestrians, bicycles, and the like. The other objects (road) also include road division lines (white lines, etc.) and stop lines. Recognized states of other objects include, for example, traffic light color (red, green or yellow) and moving speed and direction of pedestrians and bicycles. A part of a stationary object among other objects, constitutes a landmark serving as an index of position on the map, and the external environment recognition unit 14 also recognizes the position and type of the landmark.

The action plan generation unit 15 generates a driving path (target path) of the subject vehicle from present time point to a certain time ahead based on, for example, a target route computed by the navigation unit 6, map information stored in the memory unit 12, subject vehicle position recognized by the subject vehicle position recognition unit 13, and external circumstances recognized by the external environment recognition unit 14. When multiple paths are available on the target route as target path candidates, the action plan generation unit 15 selects from among them the path that optimally satisfies legal compliance, safe efficient driving and other criteria, and defines the selected path as the target path. The action plan generation unit 15 then generates an action plan matched to the generated target path. An action plan is also called “travel plan”. The action plan generation unit 15 generates various kinds of action plans corresponding to overtake traveling for overtaking the forward vehicle, lane-change traveling to move from one traffic lane to another, following traveling to follow the preceding vehicle, lane-keep traveling to maintain same lane, deceleration or acceleration traveling. When generating a target path, the action plan generation unit 15 first decides a drive mode and generates the target path in line with the drive mode.

In self-drive mode, the driving control unit 16 controls the actuators AC to drive the subject vehicle along target path generated by the action plan generation unit 15. More specifically, the driving control unit 16 calculates required driving force for achieving the target accelerations of sequential unit times calculated by the action plan generation unit 15, taking running resistance caused by road gradient and the like into account. And the driving control unit 16 feedback-controls the actuators AC to bring actual acceleration detected by the internal sensor group 2, for example, into coincidence with target acceleration. In other words, the driving control unit 16 controls the actuators AC so that the subject vehicle travels at target speed and target acceleration. On the other hand, in manual drive mode, the driving control unit 16 controls the actuators AC in accordance with driving instructions by the driver (steering operation and the like) acquired from the internal sensor group 2.

The map generation unit 17 generates the environment map constituted by three-dimensional point cloud data using detection values detected by the external sensor group 1 during traveling in the manual drive mode. Specifically, an edge indicating an outline of an object is extracted from a camera image acquired by the camera based on luminance and color information for each pixel, and a feature point is extracted using the edge information. The feature point is, for example, an intersection of the edges, and corresponds to a road division line, a corner of a building, a corner of a road sign, or the like. The map generation unit 17 calculates the distance to the extracted feature point and sequentially plots the feature point on the environment map, thereby generating the environment map around the road on which the subject vehicle has traveled. The environment map may be generated by extracting the feature point of an object around the subject vehicle using data acquired by radar or LIDAR instead of the camera.

The subject vehicle position recognition unit 13 performs subject vehicle position estimation processing in parallel with map creation processing by the map generation unit 17. That is, the position of the subject vehicle is estimated based on a change in the position of the feature point over time. The map creation processing and the position estimation processing are simultaneously performed, for example, according to an algorithm of SLAM using signals from the camera or LIDAR. The map generation unit 17 can generate the environment map not only when the vehicle travels in the manual drive mode but also when the vehicle travels in the self-drive mode. If the environment map has already been generated and stored in the memory unit 12, the map generation unit 17 may update the environment map with a newly obtained feature point.

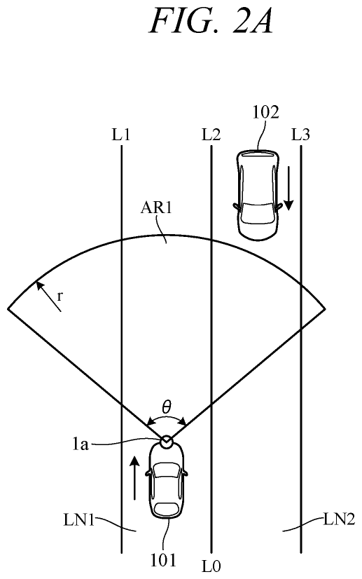

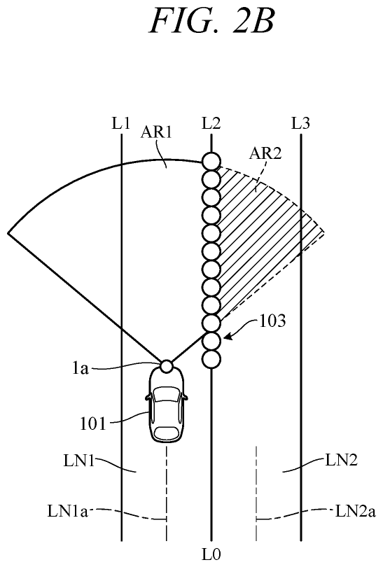

A configuration of a map generation apparatus according to the present embodiment will be described. FIG. 2A is a diagram illustrating an example of a driving scene to which the map generation apparatus 50 according to the present embodiment is applied, and illustrates a middle of a scene in which a subject vehicle 101 travels while generating an environmental map in a manual drive mode, that is, the subject vehicle travels on the current lane (first lane LN1) defined by left and right division lines L1 and L2. FIG. 2A also illustrates another vehicle 102 traveling on opposite lane extending parallel to the current lane and opposite to the current lane, that is, the opposite lane (second lane LN2) defined by left and right division lines L2 and L3. Assuming that the vehicle 101 travels along the first lane LN1 to its destination and then returns along the second lane LN2, the first lane LN1 may be referred to as an outward path and the second lane LN2 as a return path.

As illustrated in FIG. 2A, a camera 1a is mounted on a front portion of the subject vehicle 101. The camera 1a has a unique viewing angle θ determined by the performance of the camera and a maximum detection distance r. An inside of a fan-shaped area AR1 having a radius r and a central angle θ centered on the camera 1a is an area of an external space detectable by the camera 1a, that is, a detectable area AR1. The detectable area AR1 includes, for example, a plurality of division lines (for example, white lines) L1 to L3. In other words, the detectable area AR1 includes not only the division lines L1 and L2 for the current lane, but also the division lines L2 and L3 for the opposite lane. Note that, in a case where a part of the viewing angle of the camera 1a is blocked by the presence of components disposed around the camera 1a, the detectable area AR1 may be different from the illustrated area.

FIG. 2B is a diagram illustrating another example of the driving scene to which the map generation apparatus according to the present embodiment is applied. As illustrated in FIG. 2B, an obstacle 103 that prevents imaging by the camera 1a of the subject vehicle 101 is disposed along a boundary line L0 that is a boundary between the lanes LN1 and LN2, between the first lane LN1 and the second lane LN2. The obstacle 103 is, for example, a tree, a median strip, a guardrail, a signboard, or the like. With the arrangement of the obstacle 103, it becomes impossible to acquire a camera image of an area AR2 indicated by a dotted line hatched in the detectable area AR1.

In FIG. 2B, the division line L2 is matched with the boundary line L0. However, in actuality, the division line L2 and boundary line L0 are not necessarily matched with each other. The boundary line L0 is located at the center between a first center line LN1a extending along the first lane LN1 through the center in a vehicle width direction of the first lane LN1 and a second center line LN2a extending along the second lane LN2 through the center in a vehicle width direction of the second lane LN2. Therefore, for example, on a road having a median strip, there is the boundary line L0 between a division line on the inner side in the vehicle width direction (the side of the median strip) of the first lane LN1 and a division line on the inner side in the vehicle width direction (the side of the median strip) of the second lane LN2, and the division line L2 and the boundary line L0 are different. FIGS. 2A and 2B illustrate an example in which the outward path and the return path are constituted by the single lanes LN1 and LN2, respectively, but both the outward path and the return path may be constituted by a plurality of lanes. In this case, the boundary line L0 exists between the innermost lane of the outward path and the innermost lane of the return path in the vehicle width direction.

In such a driving scene, by extracting edge points from a camera image acquired while the subject vehicle 101 travels on the current lane, it is possible to generate a map of the current lane (first lane LN1) included in the detectable area AR1. However, if the subject vehicle 101 should travel on the opposite lane in order to generate a map of the opposite lane (second lane LN2), it is difficult to efficiently generate the map. Therefore, in order to efficiently generate the maps of both the current lane and the opposite lane, the present embodiment configures a map generation apparatus as follows.

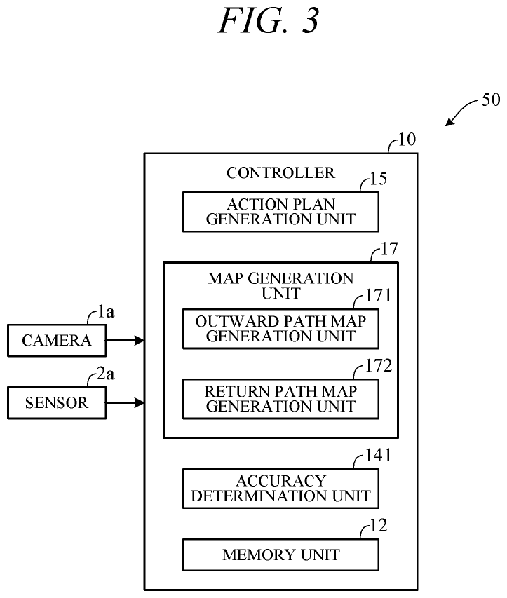

FIG. 3 is a block diagram illustrating a main configuration of a map generation apparatus 50 according to the present embodiment. The map generation apparatus 50 constitutes a part of a vehicle control system 100 in FIG. 1. As illustrated in FIG. 3, the map generation apparatus 50 has a controller 10, a camera 1a, and a sensor 2a.

The camera 1a is a monocular camera having an imaging element (image sensor) such as a CCD or a CMOS, and constitutes a part of the external sensor group 1 in FIG. 1. The camera 1a may be a stereo camera. The camera 1a is attached to, for example, a predetermined position in the front portion of the subject vehicle 101 (FIG. 2A), continuously captures an image of a space in front of the subject vehicle 101, and acquires an image (camera image) of a target object. The target object includes a division line (for example, the division lines L1 to L3 in FIG. 2A) on a road. Note that the target object may be detected by a LiDAR or the like instead of the camera 1a or together with the camera 1a.

The sensor 2a is a detection part used to calculate a movement amount and a movement direction of the subject vehicle 101. The sensor 2a is a part of the internal sensor group 2, and includes, for example, a vehicle speed sensor and a yaw rate sensor. That is, the controller 10 (for example, a subject vehicle position recognition unit 13 in FIG. 1) calculates the movement amount of the subject vehicle 101 by integrating a vehicle speed detected by the vehicle speed sensor, calculates a yaw angle by integrating the yaw rate detected by the yaw rate sensor, and estimates a position of the subject vehicle 101 by odometry. For example, when the vehicle travels in the manual drive mode, the position of the subject vehicle is estimated by odometry when the environmental map is created. Note that the configuration of the sensor 2a is not limited thereto, and the position of the subject vehicle may be estimated using information of other sensor.

The controller 10 in FIG. 3 has an accuracy determination unit 141 in addition to an action plan generation unit 15 and a map generation unit 17, as a functional configuration of a processing unit 11 (FIG. 1). The accuracy determination unit 141 has a function for recognizing an external environment, and is included in the external environment recognition unit 14 in FIG. 1. The accuracy determination unit 141 also has a map generation function. Therefore, the accuracy determination unit 141 can also be included in the map generation unit 17.

The accuracy determination unit 141 determines whether or not the detection accuracy of the second lane LN2 by the camera 1a is a predetermined value a or more on the basis of the camera image acquired by the camera 1a at the time of traveling on the first lane LN1. This determination is a determination as to whether or not the division lines L2 and L3 of the second lane LN2 are included in the detectable area AR1 of the camera 1a. For example, as illustrated in FIG. 2A, when there is no obstacle on the boundary line L0, not only the division lines L1 and L2 of the first lane LN1 but also the division lines L2 and L3 of the second lane LN2 are included in the detectable area AR1 of the camera 1a. In this case, edges corresponding to the division lines L2 and L3 are recognized in the acquired camera image. Therefore, the accuracy determination unit 141 determines that the detection accuracy is the predetermined value a or more.

On the other hand, as illustrated in FIG. 2B, when the obstacle 103 exists along the boundary line L0, imaging by the camera 1a is blocked by the obstacle 103, and the division lines L2 and L3 of the second lane LN2 are not included in the detectable area AR1 of the camera 1a. In this case, since the edges corresponding to the division lines L2 and L3 are not recognized in the acquired camera image, the accuracy determination unit 141 determines that the detection accuracy is less than the predetermined value a. When the edges of the division lines L2 and L3 in the acquired camera image are recognized as a predetermined length or more, it may be determined that the detection accuracy is the predetermined value a or more. The environmental map also includes information of a building and the like around the lanes LN1 and LN2. Therefore, when the acquired camera image does not include an image of the building or the like around the second lane LN2 in a predetermined range or more, it may be determined that the detection accuracy is less than the predetermined value a.

The map generation unit 17 has an outward path map generation unit 171 that generates an environmental map (outward path map) of an outward path which is the first lane LN1, and a return path map generation unit 172 that generates an environmental map (return path map) of a return path which is the second lane LN2. At the time of traveling on the outward path in the manual drive mode, the outward path map generation unit 171 extracts feature points of objects (the building, the division lines L1 and L2, and the like) around the subject vehicle 101 on the basis of a camera image acquired by the camera 1a, and estimates a position of the subject vehicle by the sensor 2a, thereby generating the environmental map of the outward path. The generated outward path map is stored in the memory unit 12. At this time, the outward path map generation unit 171 recognizes the positions of the division lines L1 and L2 (FIG. 2A) in the detectable area AR1 of the camera 1a, and stores information of the division lines L1 and L2 in map information (for example, internal map information).

When it is determined by the accuracy determination unit 141 that the detection accuracy of the second lane LN2 by the camera 1a is the predetermined value a or more at the time of traveling on the outward path in the manual drive mode, the return path map generation unit 172 generates the environmental map of the return path. That is, in this case, as illustrated in FIG. 2A, since the division lines L2 and L3 of the second lane LN2 are included in the detectable area AR1, the feature points of the objects around the subject vehicle 101 are extracted on the basis of the camera image, and the position of the subject vehicle is estimated by the sensor 2a, thereby generating the environmental map of the return path. The generated return path map is stored in the memory unit 12. At this time, the return path map generation unit 172 recognizes the positions of the division lines L2 and L3 (FIG. 2A) within the detectable area AR1 of the camera 1a, and stores information of the division lines L2 and L3 in the map information.

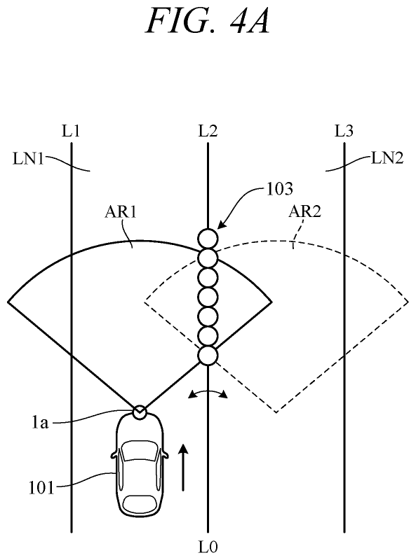

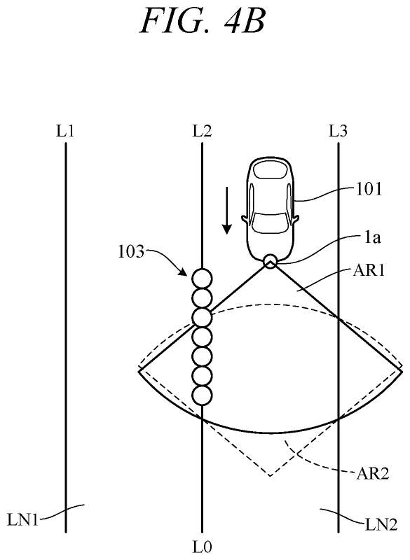

On the other hand, when it is determined by the accuracy determination unit 141 that the detection accuracy is less than the predetermined value a at the time of traveling on the outward path in the manual drive mode, the return path map generation unit 172 generates a return path map as follows. First, a boundary line L0 between the first lane LN1 and the second lane LN2 is set on the basis of the camera image. Next, an environmental map of the outward path is moved symmetrically with the boundary line L0 as a symmetry axis. That is, the outward path map is bisymmetrically inverted by mirroring. In other words, inversion is performed symmetrically in a direction diagonally opposite to the outward path map. As a result, as indicated by a dotted line in FIG. 4A, an environmental map of the return path in an area (referred to as a mirroring area) AR2 obtained by symmetrically moving the detectable area AR1 is obtained. The mirroring area AR2 includes the division lines L2 and L3 of the second lane LN2. Therefore, map information including division line information is obtained by mirroring. The map information is stored in the memory unit 12.

The return path map obtained by the mirroring is not obtained by actually imaging the second lane LN2, but is a map predicted on the assumption that the first lane LN1 and the second lane LN2 are symmetric. Therefore, the obtained return path map is a simple map and corresponds to a temporary map. After generating the temporary map, the return path map generation unit 172 updates the map information of the temporary map with the camera image obtained when the subject vehicle 101 travels on the return path in the manual drive mode, for example. That is, as illustrated in FIG. 4B, since the mirroring area AR2 in which the temporary map has been generated by the mirroring and the detectable area AR1 of the camera 1a at the time of traveling on the return path overlap with each other, the return path map generation unit 172 combines or matches the map data of the temporary map with the map data based on the camera image obtained at the time of traveling on the return path to update the map information. The updated map information is stored in the memory unit 12.

The updated map corresponds to the environmental map obtained by the camera image at the time of traveling on the return path, and is the complete environmental map of the return path. However, at the time of traveling on the return path, since the temporary map of the return path is generated in advance, it is not necessary to generate the return path map from the beginning. Therefore, the return path map can be efficiently generated, and the processing load of the controller 10 can be reduced. In this way, in the present embodiment, when the environmental map of the outward path is generated, the environmental map of the return path is simultaneously generated.

The action plan generation unit 15 sets a target route when the subject vehicle 101 travels on the return path using the map information of the environmental map of the return path (second lane LN2) obtained at the time of traveling on the outward path (first lane LN1). The driving control unit 16 (FIG. 1) controls the actuator AC so that the subject vehicle 101 automatically travels along the target route. As a result, even if the vehicle has not traveled on the return path in the manual drive mode, that is, even when the vehicle travels on the return path for the first time, the vehicle can travel in the self-drive mode.

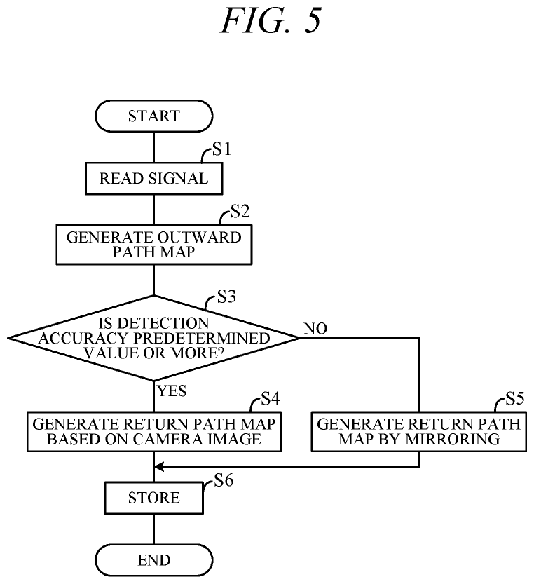

FIG. 5 is a flowchart illustrating an example of processing executed by the controller 10 of FIG. 3 according to a predetermined program. The processing illustrated in the flowchart is started when the vehicle travels on the first lane LN1 in the manual drive mode, and is repeated at a predetermined cycle.

As illustrated in FIG. 5, first, signals from the camera 1a and the sensor 2a are read in S1 (S: processing step). Next, in S2, an environmental map (outward path map) of the outward path (first lane LN1) is generated on the basis of the read signals (camera image or the like). Next, in S3, it is determined whether or not the detection accuracy of the second lane LN2 by the camera 1a at the time of traveling on the outward path is a predetermined value a or more, on the basis of the camera image read in S1. In a case where the result of determination in S3 is YES, the process proceeds to S4, and in a case where the result of determination in S3 is NO, the process proceeds to S5.

In S4, an environmental map (return path map) of the return path (second lane LN2) is generated on the basis of the camera image read in S1. For example, as illustrated in FIG. 2A, the return path map is generated on the basis of the camera image of the second lane LN2 among the camera images within the detectable area AR1 of the camera 1a. On the other hand, in S5, the return path map is generated by mirroring of the outward path map. For example, the return path map within the mirroring area AR2 indicated by a dotted line in FIG. 4A is generated. Next, in S6, the map information of the outward path map generated in S2 and the return path map generated in S4, or the outward path map generated in S2 and the return path map generated in S5 is stored in the memory unit 12, and the processing ends.

The operation of the map generation apparatus 50 according to the present embodiment is summarized as follows. As illustrated in FIG. 2A, when the subject vehicle 101 travels on the outward path (first lane LN1) to the destination in the manual drive mode, the environmental map of the outward path within the detectable area AR1 of the camera 1a including the position information of the division lines L1 and L2 is generated on the basis of the camera image (S2). At this time, when it is determined that the second lane LN2 is included in the camera image and the detection accuracy of the second lane LN2 by the camera 1a is the predetermined value a or more, the environmental map of the return path (second lane LN2) is simultaneously generated on the basis of the camera image at the time of traveling on the outward path (S4).

On the other hand, as illustrated in FIG. 2B, when it is determined that the obstacle 103 exists on the boundary line L0 between the first lane LN1 and the second lane LN2 and the detection accuracy of the second lane LN2 by the camera 1a is less than the predetermined value a, the environmental map of the return path within the mirroring area AR2 indicated by a dotted line in FIG. 4B is generated by mirroring of the outward path map (S5). As described above, in the present embodiment, when the outward path map is generated while traveling on the first lane LN1, the return path map for the second lane LN2 is also generated at the same time regardless of the presence or absence of the obstacle 103 on the boundary line L0.

As a result, it is possible to generate the return path map even before the vehicle actually travels on the return path in the manual drive mode. Therefore, it is possible to set the target route when the vehicle travels on the return path in the self-drive mode on the basis of the return path map, and the vehicle can travel on the return path in the self-drive mode. In this case, when the detection accuracy of the second lane LN2 by the camera 1a is the predetermined value a or more, the map generation is performed using the actual camera image in preference to the map generation by the mirroring, so that the return path map can be created with high accuracy.

According to the present embodiment, following functions and effects can be achieved.

(1) The map generation apparatus 50 includes a camera 1a that detects an external situation around the subject vehicle 101; and a map generation unit 17 that simultaneously generates an outward path map for a current lane (first lane LN1) on which the subject vehicle 101 travels and a return path map for an opposite lane (second lane LN2) opposite to the current lane, on the basis of the external situation detected by the camera 1a (FIG. 1). As a result, since the return path map is generated simultaneously with the outward path map at the time of traveling on the outward path, the return path map can be generated without traveling on the return path, and efficient map generation can be performed.

(2) The map generation apparatus 50 further includes an accuracy determination unit 141 that determines whether or not detection accuracy of the external situation for the second lane LN2 detected by the camera 1a is a predetermined value a or more (FIG. 3). When it is determined by the accuracy determination unit 141 that the detection accuracy is the predetermined value a or more, the map generation unit 17 (return path map generation unit 172) generates the return path map on the basis of the external situation of the second lane LN2 detected by the camera 1a, and when it is determined that the detection accuracy is less than the predetermined value a, the map generation unit 17 generates the return path map by inverting the outward path map (FIG. 5). When the detection accuracy of the external situation is poor, it is difficult to generate the return path map using the camera image as it is. However, by inverting the outward path map, the return path map of the second lane LN2 on which the subject vehicle 101 has not traveled can also be easily created, and the map generation can be efficiently performed.

(3) When it is determined by the accuracy determination unit 141 that the detection accuracy is less than the predetermined value a, the return path map generation unit 172 generates the return path map by symmetrically moving (moving in a line-symmetric manner) the outward path map with the boundary line L0 between the first lane LN1 and the second lane LN2 as a symmetry axis (FIG. 4A). As a result, it is possible to favorably generate the return path map using the outward path map. That is, since the outward path and the return path are often formed symmetrically, the return path map can be generated favorably by mirroring.

(4) The return path map generation unit 172 simultaneously generates the outward path map and the return path map while the subject vehicle 101 travels on the first lane LN1, on the basis of the external situation detected by the camera 1a when the subject vehicle 101 travels on the first lane LN1 (FIG. 5). As a result, when the outward path map is generated while the vehicle travels on the outward path using an algorithm such as SLAM, the return path map is also generated, and the maps of the outward path and the return path can be generated early.

(5) The map generation apparatus 50 further includes an action plan generation unit 15 (a route setting unit) that sets a target route when the subject vehicle 101 travels on the second lane LN2, on the basis of the return path map generated by the map generation unit 17 (FIG. 3). This enables traveling in the self-drive mode even before traveling in the manual drive mode for generating the environmental map.

The above embodiment may be modified into various forms. Some modifications will be described below. In the above embodiment, the external sensor group 1, which is an in-vehicle detector such as the camera 1a, detects the external situation around the subject vehicle 101. However, the external situation may be detected using an in-vehicle detector such as a LiDAR other than the camera 1a or a detection device other than the in-vehicle detector. Information from an in-vehicle detector (camera or the like) mounted on an oncoming vehicle traveling on an opposite lane may be acquired via the communication unit 7, and the outward path map or the return path map may be generated. In the above embodiment, the outward path map generation unit 171 generates the outward path map (a first map) on the basis of the external situation detected by the camera 1a when the subject vehicle 101 travels on the first lane LN1 (current lane), and generates the return path map (a second map) in different modes on the basis of the determination result of the accuracy determination unit 141. However, a map generation unit may have any configuration as long as the first map and the second map are simultaneously generated.

In the above embodiment, when it is determined that the detection accuracy for the opposite lane detected by the camera 1a is less than the predetermined value a, the return path map is generated by symmetrically moving (moving in a line-symmetric manner) the outward path map with the boundary line L0 between the current lane and the opposite lane as a symmetry axis. However, the inversion mode of the outward path map is not limited to line symmetry in which the boundary line is symmetric line. In the above embodiment, when it is determined that the detection accuracy for the opposite lane detected by the camera 1a is less than the predetermined value a, the action plan generation unit 15 as a route setting unit sets the target route for self-driving in traveling on the return path using the map (a temporary map) generated by the mirroring. However, the target route for self-driving may be set using a complete return path map instead of using the temporary map.

In the above embodiment, the outward path map and the return path map obtained when the subject vehicle 101 travels on the outward path are stored in the memory unit 12. However, these pieces of map information may be further transmitted to a server via the communication unit 7. In a case where there is other vehicle having a map generation function similar to that of the present embodiment, that is, in a case where there is other vehicle that generates a map on the basis of an external situation of a detection device, map information may be transmitted to and received from other vehicle via the communication unit 7.

In the above embodiment, the example in which the map generation apparatus is applied to the self-driving vehicle has been described. That is, the example in which the self-driving vehicle generates the environmental map has been described. However, the present invention can be similarly applied to a case where a manual driving vehicle having or not having a driving support function generates the environmental map.

The present invention can also be used as a map generation method including detecting an external situation around a subject vehicle 101 by a detection device such as a camera 1a, and simultaneously generating a first map for a current lane LN1 on which the subject vehicle 101 travels and a second map for an opposite lane LN2 opposite to the current lane LN1, based on the detected external situation.

The above embodiment can be combined as desired with one or more of the above modifications. The modifications can also be combined with one another.

According to the present invention, it is possible to generate a map for a lane on which a subject vehicle has not traveled yet, and a map generation can be efficiently performed.

Above, while the present invention has been described with reference to the preferred embodiments thereof, it will be understood, by those skilled in the art, that various changes and modifications may be made thereto without departing from the scope of the appended claims.

What is claimed is:

1. A map generation apparatus, comprising:
a detection device that detects an external situation around a subject vehicle; and
an electronic control unit including a microprocessor and a memory connected to the microprocessor,
the microprocessor is configured to perform
generating simultaneously a first map for a current lane on which the subject vehicle travels and a second map for an opposite lane opposite to the current lane, based on the external situation detected by the detection device.

2. The map generation apparatus according to claim 1, wherein
the microprocessor is configured to further perform
determining whether a detection accuracy of the external situation for the opposite lane detected by the detection device is more than or equal to a predetermined value, and
the microprocessor is configured to perform
the generating including generating the second map based on the external situation for the opposite lane detected by the detection device when it is determined that the detection accuracy is more than or equal to the predetermined value, while the second map by inverting the first map when it is determined that the detection accuracy is less than the predetermined value.

3. The map generation apparatus according to claim 2, wherein
the opposite lane is defined by a left and right division lines, and
the microprocessor is configured to perform
the determining including determining that the detection accuracy is more than or equal to the predetermined value when the left and right division lines are included in a detectable area of the detection device.

4. The map generation apparatus according to claim 2, wherein
the opposite lane is defined by a left and right division lines, and
the microprocessor is configured to perform
the generating including generating the second map by symmetrically moving the first map with a boundary line between the current lane and the opposite lane as a symmetry axis when it is determined that the detection accuracy is less than the predetermined value.

5. The map generation apparatus according to claim 4, wherein
the microprocessor is configured to perform
the generating including updating the second map based on the external situation detected by the detection device when the subject vehicle travels on the opposite lane after generating the second map by symmetrically moving the first map.

6. The map generation apparatus according to claim 1, wherein
the detection device is mounted on the subject vehicle, and
the microprocessor is configured to perform
the generating including simultaneously generating the first map and the second map during traveling on the current lane, based on the external situation detected by the detection device when the subject vehicle travels on the current lane.

7. The map generation apparatus according to claim 1, wherein
the microprocessor is configured to further perform
setting a target route when the subject vehicle travels on the opposite lane, based on the second map generated.

8. The map generation apparatus according to claim 7, wherein
the subject vehicle is a self-driving vehicle having a self-driving capability, and
the microprocessor is configured to perform
the setting including setting the target route used when the subject vehicle travels on the opposite lane by self-driving.

9. A map generation apparatus, comprising:
a detection device that detects an external situation around a subject vehicle; and
an electronic control unit including a microprocessor and a memory connected to the microprocessor,
the microprocessor is configured to function as
a map generation unit that simultaneously generates a first map for a current lane on which the subject vehicle travels and a second map for an opposite lane opposite to the current lane, based on the external situation detected by the detection device.

10. The map generation apparatus according to claim 9, wherein
the microprocessor is configured to further function as
an accuracy determination unit that determines whether a detection accuracy of the external situation for the opposite lane detected by the detection device is more than or equal to a predetermined value, and
the map generation unit generates the second map based on the external situation for the opposite lane detected by the detection device when it is determined by the accuracy determination unit that the detection accuracy is more than or equal to the predetermined value, while the second map by inverting the first map when it is determined that the detection accuracy is less than the predetermined value.

11. The map generation apparatus according to claim 10, wherein
the opposite lane is defined by a left and right division lines, and
the accuracy determination unit determines that the detection accuracy is more than or equal to the predetermined value when the left and right division lines are included in a detectable area of the detection device.

12. The map generation apparatus according to claim 10, wherein
the opposite lane is defined by a left and right division lines, and
the map generation unit generates the second map by symmetrically moving the first map with a boundary line between the current lane and the opposite lane as a symmetry axis when it is determined by the accuracy determination unit that the detection accuracy is less than the predetermined value.

13. The map generation apparatus according to claim 12, wherein
the map generation unit updates the second map based on the external situation detected by the detection device when the subject vehicle travels on the opposite lane after generating the second map by symmetrically moving the first map.

14. The map generation apparatus according to claim 10, wherein
the detection device is mounted on the subject vehicle, and
the map generation unit simultaneously generates the first map and the second map during traveling on the current lane, based on the external situation detected by the detection device when the subject vehicle travels on the current lane.

15. The map generation apparatus according to claim 10, wherein
the microprocessor is configured to further function as
a route setting unit that sets a target route when the subject vehicle travels on the opposite lane, based on the second map generated by the map generation unit.

16. The map generation apparatus according to claim 15, wherein
the subject vehicle is a self-driving vehicle having a self-driving capability, and
the route setting unit sets the target route used when the subject vehicle travels on the opposite lane by self-driving.

17. A map generation method, comprising:
detecting an external situation around a subject vehicle by a detection device; and
simultaneously generating a first map for a current lane on which the subject vehicle travels and a second map for an opposite lane opposite to the current lane, based on the external situation detected by the detection device.
